(19) United States
(12) Patent Application Publication
(10) Pub. No.: US 2022/0210575 A1
(43) Pub. Date: Jun. 30, 2022

(54) NEW LOUDSPEAKER STRUCTURE

(71) Applicant: XIAMEN SOUND'S GREAT ELECTRONICS AND TECHNOLOGY CO., LTD., Xiamen, Fujian (CN)

(72) Inventors: Hongda Zhou, Taipei City (TW); Jungwai Wu, Taipei City (TW)

(21) Appl. No.: 17/605,560

(22) PCT Filed: Apr. 24, 2019
(86) PCT No.: PCT/CN2019/084071

§ 371 Date: Oct. 21, 2021

(51) Int. Cl. H04R 9/06; H04R 9/04; H04R 9/02; H04R 7/02; H04R 7/18

(52) U.S. Cl. CPC H04R 9/06; H04R 9/045; H04R 7/18; H04R 7/02; H04R 9/025

(57) ABSTRACT

A new loudspeaker structure comprises a housing, a coil assembly and a magnetic vibration diaphragm, wherein the coil assembly is fixed on the housing, and the coil assembly is provided with a connection end connected to an external power source; and the magnetic vibration diaphragm is connected to the housing, and a vibration space for vibration of the magnetic vibration diaphragm is formed between the magnetic vibration diaphragm and the coil assembly. According to the loudspeaker structure of the present invention, a vibration diaphragm is provided as a magnetic vibration diaphragm, thereby removing a bulky magnet, reducing the volume of the loudspeaker structure, and realizing the miniaturization of the loudspeaker structure, so that the application of the loudspeaker structure is more flexible.

### BACKGROUND OF THE INVENTION

### 1. Field of the Invention

The present invention relates to a loudspeaker, and more particularly to a new loudspeaker structure.

### 2. Description of the Prior Art

A loudspeaker is an important acoustic component of an electronic device, and is a transducer that converts electrical signals into acoustic signals.

A conventional loudspeaker structure generally includes a magnet, a coil, and a vibration diaphragm connected to the coil. The coil is energized to generate a magnetic field, which changes the force of the coil in the magnetic field of the magnet. When the energized current of the coil changes, the force received by the coil will also change, so as to generate vibrations. At the same time, the vibration diaphragm connected to the coil also vibrates to emit sound and complete the conversion of electrical signals to acoustic signals.

In the conventional loudspeaker structure, the magnet occupies a larger space. The loudspeaker has a relatively large structure, which limits its use in handheld electronic devices and ultra-thin electronic devices. Therefore, how to provide a miniaturized loudspeaker structure to meet the needs of ultra-thinness or miniaturization of the electronic device to which it is applied has become a problem to be solved.

### SUMMARY OF THE INVENTION

In view of the above problems, the primary object of the present invention is to provide a new loudspeaker structure with a small volume.

In order to achieve the above object, the present invention adopts the following technical solutions.

A new loudspeaker structure comprises a housing, a coil assembly, and a magnetic vibration diaphragm. The coil assembly is fixed on the housing. The coil assembly includes a connection end connected to an external power source. The magnetic vibration diaphragm is connected to the housing. A vibration space for vibration of the magnetic vibration diaphragm is formed between the magnetic vibration diaphragm and the coil assembly.

The magnetic vibration diaphragm is directly connected to the housing, or connected to the housing through an elastic member or a limiting groove.

The magnetic vibration diaphragm is a permanent magnetic vibration diaphragm or an electromagnetic vibration diaphragm.

The magnetic vibration diaphragm is formed by energizing coils embedded in the vibration diaphragm. The coil assembly is embedded in a vibration diaphragm and connected to the housing through the vibration diaphragm.

A magnetic substance is provided on the magnetic vibration diaphragm or the vibration diaphragm of the coil assembly.

The magnetic vibration diaphragm is a sheet structure, a spherical structure, a cone structure, a flat structure, a dome structure, or a horn structure.

The coil assembly includes a wire coil disposed on the housing.

A substrate is connected to the housing. The wire coil is wound on the substrate.

The wire coil is a spiral structure.

The coil assembly includes more than two sets of wire coils. Each set of wire coils includes has the connection end connected to the external power source.

The coil assembly includes more than two sets of wire coils. Each set of wire coils has the connection end connected to the external power source. The more than two sets of wire coils are arranged in a petal-shaped structure.

The coil assembly includes a printed coil or an etched coil disposed on the housing.

The coil assembly further includes a substrate fixed on the housing. The printed coil or the etched coil is disposed on the substrate.

The printed coil or the etched coil is a spiral structure.

The coil assembly includes more than two sets of printed coils or etched coils. Each set of printed coils or etched coils has the connection end connected to the external power source. The more than two sets of printed coils or etched coils are arranged concentrically.

The coil assembly includes more than two sets of printed coils or etched coils. Each set of printed coils or etched coils has the connection end connected to the external power source. The more than two sets of printed coils or etched coils are arranged in a petal-shaped structure.

According to the loudspeaker structure of the present invention, a vibration diaphragm is provided as a magnetic vibration diaphragm, thereby removing a bulky magnet, reducing the volume of the loudspeaker structure, and realizing the miniaturization of the loudspeaker structure, so that the application of the loudspeaker structure is more flexible. Because the magnetic vibration diaphragm is used, the magnetic field of the magnetic vibration diaphragm is closer to the magnetic field of the coil assembly, which improves the sound effect of the loudspeaker structure. Moreover, the use of the magnetic vibration diaphragm allows the magnetic field to directly control the vibration diaphragm and determine the sound effect, which further improves the sound effect of the loudspeaker structure and reduces distortion. In addition, the loudspeaker structure of the present invention enables the stressed area of the magnetic vibration diaphragm to be larger, improves the efficiency of converting electrical signals into acoustic signals, and saves power greatly. The electromagnetic vibration diaphragm uses the mutual electromagnetic as the source of the magnetic field, and the coil is removed.

### BRIEF DESCRIPTION OF THE DRAWINGS

FIG. 1 is a schematic view of the loudspeaker structure according to a first embodiment of the present invention;

FIG. 2 is a schematic view of the loudspeaker structure according to a second embodiment of the present invention;

FIG. 3 is a schematic view of the loudspeaker structure according to a third embodiment of the present invention;

FIG. 4 is a schematic view of the loudspeaker structure according to a fourth embodiment of the present invention;

FIG. 5 is a schematic view of the loudspeaker structure according to a fifth embodiment of the present invention;

FIG. 6 is a schematic view of the coil assembly according to the first to fifth embodiments of the present invention;

FIG. 7 is a schematic view of the loudspeaker structure according to a sixth embodiment of the present invention;

FIG. 8 is a schematic view of an implementation of the coil assembly in the form of a multi-coil structure of the present invention;

FIG. 9 is a schematic view of another implementation of the coil assembly in the form of a multi-coil structure of the present invention;

FIG. 10 is a schematic view of the irregular magnetic vibration diaphragm corresponding to FIG. 9;

FIG. 11 is a schematic view of an implementation of the magnetic vibration diaphragm of the present invention; and

FIG. 12 is a schematic view of another implementation of the magnetic vibration diaphragm of the present invention.

### DETAILED DESCRIPTION OF THE PREFERRED EMBODIMENTS

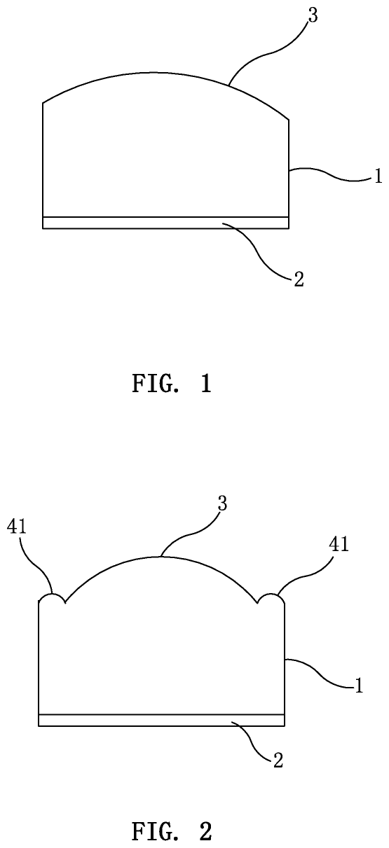

As shown in FIG. 1, the present invention discloses a new loudspeaker structure, comprising a housing 1, a coil assembly 2 and a magnetic vibration diaphragm 3, wherein the coil assembly 2 is fixed on the housing 1, and the coil assembly 2 has a connection end 21 connected to an external power source. The magnetic vibration diaphragm 3 is connected to the housing 1, and a vibration space for vibration of the magnetic vibration diaphragm 3 is formed between the magnetic vibration diaphragm 3 and the coil assembly 2.

When the loudspeaker structure is in use, the magnetic vibration diaphragm 3 will generate a magnetic field (fixed magnetic field or variable magnetic field). When the coil assembly 2 is connected to the external power source through the connecting terminal 21 and is energized, a changing magnetic field will be generated around the coil assembly 2, thereby causing the force between the coil assembly 2 and the magnetic vibration diaphragm 3 to change. Because the coil assembly 2 is fixed on the housing 1, and the magnetic vibration diaphragm 3 itself has certain elasticity, when the force between the magnetic vibration diaphragm 3 and the coil assembly 2 changes due to the energizing current, the magnetic vibration diaphragm 3 will vibrate accordingly to emit sound, completing the conversion from an electrical signal to an acoustic signal.

The magnetic source of the magnetic vibration diaphragm 3 is a permanent magnetic substance, a temporary magnetic substance, an electromagnetic substance, a diamagnetic substance, a paramagnetic substance, a ferromagnetic substance, a ferromagnetic substance, an antiferromagnetic substance, a superparamagnetic substance, a nanomagnetic substance or any other magnetic substance that is contained, embedded, integrated, chemically combined or combined in any manner outside or inside the diaphragm. The magnetic vibration diaphragm 3 may be implemented by arranging coils inside the vibration diaphragm to generate a corresponding magnetic field. In other words, the magnetic vibration diaphragm 3 may be a permanent magnetic vibration diaphragm, an electromagnetic vibration diaphragm or a nanomagnetic vibration diaphragm.

When the magnetic vibration diaphragm 3 is an electromagnetic vibration diaphragm, that is, when the magnetic vibration diaphragm 3 is formed by energizing coils embedded in a vibration diaphragm, the coil assembly 2 may be embedded in a vibration diaphragm and connected to the housing 1 through the vibration diaphragm. The winding direction of the coil assembly 2 is opposite to the winding direction of the energizing coils in the magnetic vibration diaphragm 3. The real purpose of this arrangement is to make the magnetic direction opposite. In addition, although the effect of attracting opposite poles is poor, it can also be made into a loudspeaker. In this way, the coil assembly 2 is equivalent to another magnetic vibration diaphragm, which forms a relatively mutually exclusive magnetic field with the magnetic vibration diaphragm 3, so that the magnetic vibration diaphragm 3 and the vibration diaphragm of the coil assembly 2 vibrate and emit sound at the same time. Other magnetic substance may be provided on the magnetic vibration diaphragm 3 or the vibration diaphragm of the coil assembly 2, so as to further strengthen the magnetic field.

The housing 1 is provided with air holes, which can allow the air in the loudspeaker to circulate and adjust the internal pressure of the magnetic vibration diaphragm when it vibrates. Besides, the arrangement of the air holes makes the super bass easier to represent.

Although the magnetic vibration diaphragm 3 itself has a certain degree of elasticity, when the energizing current of the coil assembly 2 increases, the force it receives will also increase. When the energizing current increases to a certain level, the magnetic vibration diaphragm 3 may be damaged. Therefore, in order to ensure the normal use of the magnetic vibration diaphragm 3, increase the amplitude of the magnetic vibration diaphragm 3 and improve the acoustic performance of the loudspeaker structure, the magnetic vibration diaphragm 3 is movably connected to the housing 1 through a connection structure. The connection structure can increase the amplitude of the magnetic vibration diaphragm 3 in the vibration space.

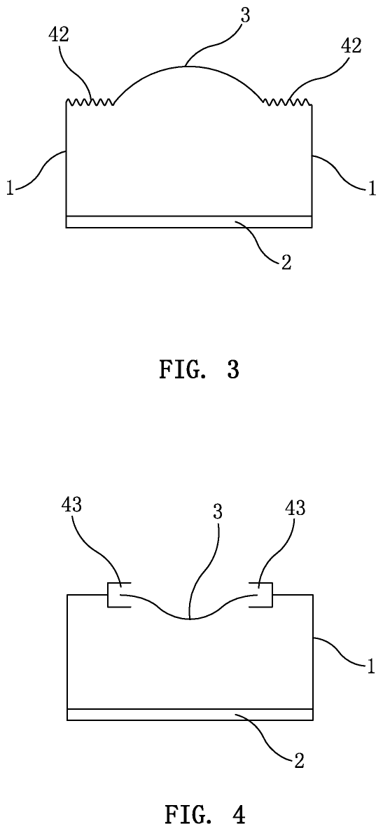

As shown in FIG. 2 and FIG. 3, the connection structure may be an elastic member, such as a folding ring 41 and a spring 42. One end of the elastic member is connected to the housing 1, and the other end is connected to the outer edge of the magnetic vibration diaphragm 3. In addition to increasing the amplitude of the magnetic vibration diaphragm 3, the elastic member also provides a return force for the magnetic vibration diaphragm 3. When the force between the magnetic vibration diaphragm 3 and the coil assembly 2 disappears, the elastic member returns the magnetic vibration diaphragm 3 to the initial position. The number of the elastic member may be one or more. When the number of the elastic member is one, the elastic member is connected to the outer edge of the entire magnetic vibration diaphragm 3. When the elastic member is plural, the plural elastic members are evenly connected to the outer edge of the magnetic vibration diaphragm 3.

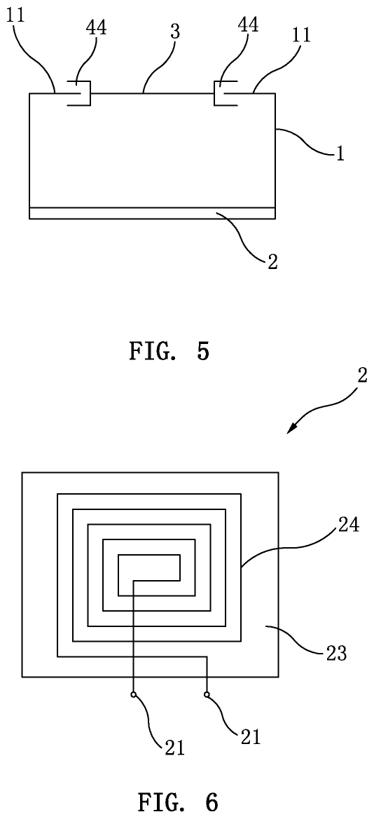

As shown in FIG. 4 and FIG. 5, the connection structure may be achieved through a limiting groove 43, 44. The limiting groove 43, 44 is formed on the housing 1 or on the magnetic vibration diaphragm 3. When the limiting groove 43 is formed on the housing 1, the opening of the limiting groove 43 faces the direction of the magnetic vibration diaphragm 3. The outer edge of the magnetic vibration diaphragm 3 is engaged in the limiting groove 43, and the thickness of the outer edge of the magnetic vibration diaphragm 3 is less than the width of the limiting groove 43. When the limiting groove 44 is formed on the magnetic vibration diaphragm 3, an engaging portion 11 is formed at one end of the housing 1 connected to the magnetic vibration diaphragm 3. The engaging portion 11 is engaged in the limiting groove 44, and the thickness of the engaging portion 11 is less than the width of the limiting groove 44. The number of the limiting groove 43, 44 may be one or more. When the number of the limiting groove 43, 44 is one, the limiting groove 43, 44 is formed in a ring shape on the housing 1 or on the magnetic vibration diaphragm 3. When there are plural limiting grooves 43, 44, the plural limiting grooves 43, 44 are evenly arranged on the housing 1 or the magnetic vibration diaphragm 3.

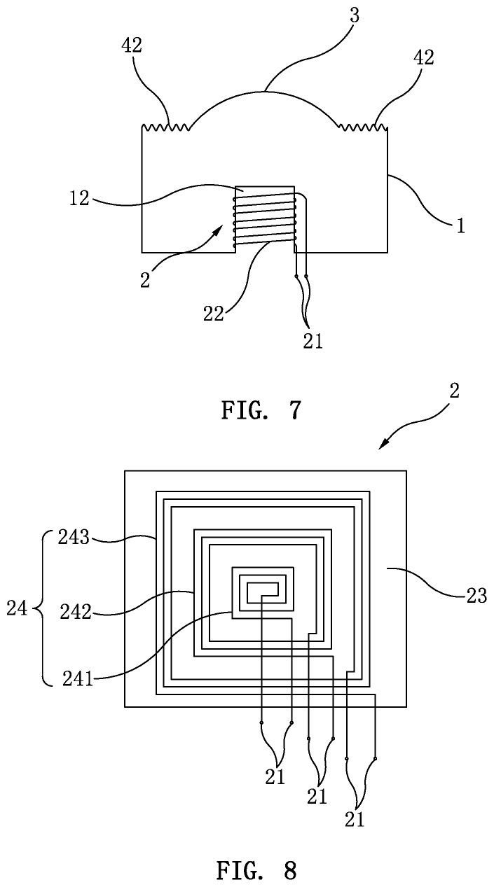

As shown in FIG. 6 and FIG. 7, the coil assembly 2 may be formed by winding, or by circuit printing or semiconductor etching technology. As shown in FIG. 7, when the coil assembly 2 is formed by winding, the coil assembly 2 includes a wire coil 22, and a spool 12 is formed at one end of the housing 1 where the coil assembly 2 is fixed and protrudes toward the direction of the magnetic vibration diaphragm 3. The wire coil 22 of the coil assembly 2 is wound on the spool 12. Of course, when the coil assembly is formed by winding, the wire coil may be directly wound on the bottom of the housing to form a spiral structure. The wire may be a copper wire, enameled wire, and other conductive wire.

As shown in FIG. 6, when the coil assembly 2 is formed by circuit printing technology, the coil assembly 2 includes a substrate 23 and a printed coil 24 printed on the substrate 23. Wherein, the substrate 23 is fixed on the housing 1. Of course, the printed coil 24 may be directly printed on the bottom of the housing 1.

When the coil assembly is formed by semiconductor etching technology, the coil assembly 2 includes a substrate and an etched coil etched on the substrate. Wherein, the substrate is fixed on the housing 1 Similarly, the etched coil may be directly etched on the bottom of the housing 1. The substrate may be a flexible substrate or a rigid substrate according to the specific use requirements.

The printed coil 24 or etched coil may be arranged in a spiral shape. The spiral shape may be a common circular spiral shape or a square spiral shape, as shown in FIG. 6. Of course, the spiral shape may be other shapes, such as a triangular spiral shape, a pentagonal spiral shape, and the like.

Compared with the coil assembly 2 formed by winding, the coil assembly 2 formed by printing and etching occupies less space, so that the loudspeaker structure occupies less space in the electronic device, which further realizes the miniaturization of the loudspeaker structure.

In order to improve the diversification of the loudspeaker structure, the coil assembly 2 may be in the form of a multi-coil structure, that is, the wire coil, the printed coil 24 and the etched coil may include two or more sets of coils. In the following, a printed coil is taken as an example The coil assembly 2 in the form of a multi-coil structure is described in detail.

When the coil assembly 2 is formed by printing, two or more sets of printed coils 24 are printed on the substrate 23 of the coil assembly 2 or the housing 1. Each set of printed coils 24 has two connection ends 21 connected to the external power source. As shown in FIG. 8, three sets of printed coils 24 are provided on the substrate 23. The three sets of printed coils 24 are defined as a first printed coil 241, a second printed coil 242 and a third printed coil 243 from the inside to the outside. The second printed coil 242 is arranged around the outer circumference of the first printed coil 241, and the third printed coil 243 is arranged around the outer circumference of the second printed coil 242. In this way, three sets of different coils correspond to different parts of the vibration diaphragm, so that different strength magnetic fields are provided to emphasize bass, alto and treble, respectively. The vibration diaphragm may be designed with different materials and thicknesses to correspond to the output of bass, alto, and treble. Specifically, the position of the magnetic vibration diaphragm 3 corresponding to the first printed coil 241 presents a bass effect, the position of the magnetic vibration diaphragm 3 corresponding to the second printed coil 242 presents an alto effect, and the position of the magnetic vibration diaphragm 3 corresponding to the third printed coil 243 presents a treble effect.

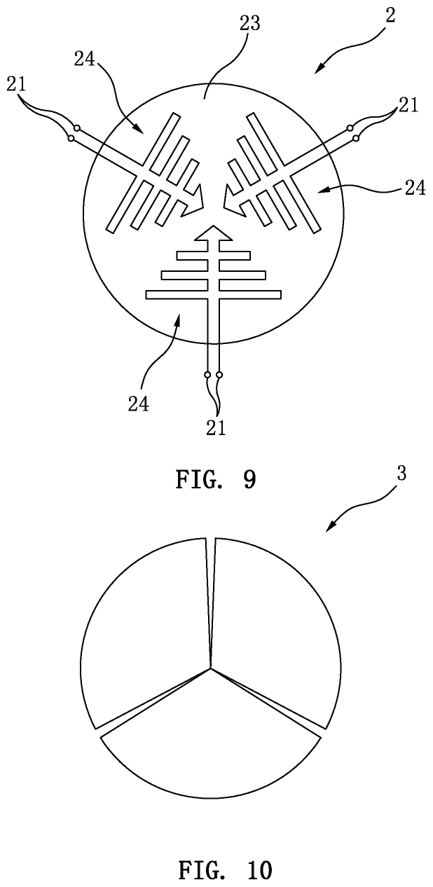

The coil assembly 2 in the form of a multi-coil structure may be arranged in a petal-shaped structure as shown in FIG. 9. As shown in FIG. 9, the circular substrate 23 of the coil assembly 2 is provided with three sets of printed coils 24. Each set of printed coils 24 is arranged in an irregular shape. The circular substrate 23 is evenly divided into three regions. The three sets of printed coils 24 are arranged in the three regions of the substrate 23, respectively. The coil assembly 2 in the form of a multi-coil structure may be in cooperation with three irregular vibration diaphragms or normal vibration diaphragms. As shown in FIG. 10, when in cooperation with three irregular magnetic vibration diaphragms, the three magnetic vibration diaphragms emit different sounds, so that one loudspeaker structure is able to emit different sounds. This increases the diversity of use of the loudspeaker structure. When in cooperation with normal magnetic vibration diaphragms 3, the power of the loudspeaker structure is increased.

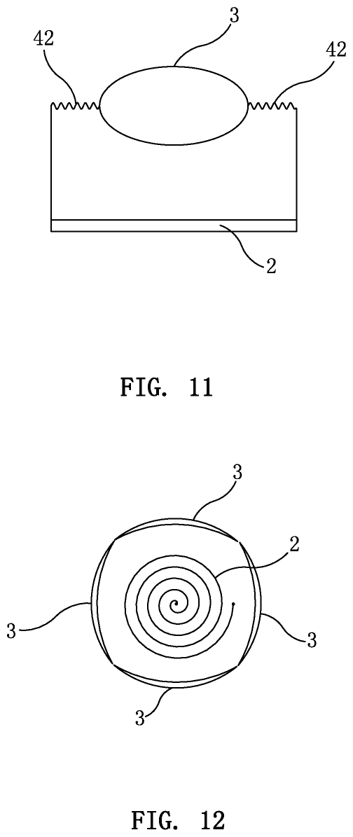

The magnetic vibration diaphragm 3 may be any structure, such as a sheet structure, a spherical structure, a cone structure, a flat structure, a dome structure, a horn structure, and so on. As shown in FIG. 11, when the magnetic vibration diaphragm 3 is a spherical structure, the sound playback of the loudspeaker is oriented. When the magnetic vibration diaphragm is spherical, the coverage of sound playback will increase several to tens of times, and the stereo effect will be more obvious, thereby optimizing the stereo sound of the loudspeaker structure. As shown in FIG. 12, when the magnetic vibration diaphragm 3 is a sheet structure, in order to optimize the stereo sound effect of the loudspeaker structure, the number of the magnetic vibration diaphragms 3 may be two or more. The two or more magnetic vibration diaphragms 3 are connected to form a ring structure and are arranged on the outer periphery of the coil assembly 2.

The feature of the present invention is that the vibration diaphragm of the present invention is magnetic, forming a magnetic vibration diaphragm 3. In this way, the loudspeaker structure only needs the housing 1, the coil assembly 2 and the magnetic vibration diaphragm 3 to emit sound, thereby realizing the conversion of electrical signals to acoustic signals. According to the loudspeaker structure of the present invention, a vibration diaphragm is provided as a magnetic vibration diaphragm 3, thereby removing a bulky magnet, reducing the volume of the loudspeaker structure, and realizing the miniaturization of the loudspeaker structure, so that the application of the loudspeaker structure is more flexible. Because the magnetic vibration diaphragm 3 is used, the magnetic field of the magnetic vibration diaphragm 3 is closer to the magnetic field of the coil assembly 2, which improves the sound effect of the loudspeaker structure. Moreover, the use of the magnetic vibration diaphragm 3 allows the magnetic field to directly control the vibration diaphragm and determine the sound effect, which further improves the sound effect of the loudspeaker structure and reduces distortion. In addition, the loudspeaker structure of the present invention enables the stressed area of the magnetic vibration diaphragm 3 to be larger, improves the efficiency of converting electrical signals into acoustic signals, and saves power greatly.

What is claimed is:

1. A new loudspeaker structure, comprising a housing, a coil assembly and a magnetic vibration diaphragm, the coil assembly being fixed on the housing, the coil assembly having a connection end connected to an external power source; the magnetic vibration diaphragm being connected to the housing, a vibration space for vibration of the magnetic vibration diaphragm being formed between the magnetic vibration diaphragm and the coil assembly.

2. The new loudspeaker structure as claimed in claim 1, wherein the magnetic vibration diaphragm is directly connected to the housing, or connected to the housing through an elastic member or a limiting groove.

3. The new loudspeaker structure as claimed in claim 1, wherein the magnetic vibration diaphragm is a permanent magnetic vibration diaphragm or an electromagnetic vibration diaphragm.

4. The new loudspeaker structure as claimed in claim 1, wherein the magnetic vibration diaphragm is formed by energizing coils embedded in the vibration diaphragm, and the coil assembly is embedded in a vibration diaphragm and connected to the housing through the vibration diaphragm.

5. The new loudspeaker structure as claimed in claim 4, wherein a magnetic substance is provided on the magnetic vibration diaphragm or the vibration diaphragm of the coil assembly.

6. The new loudspeaker structure as claimed in claim 1, wherein the magnetic vibration diaphragm is a sheet structure, a spherical structure, a cone structure, a flat structure, a dome structure, or a horn structure.

7. The new loudspeaker structure as claimed in claim 1, wherein the coil assembly includes a wire coil disposed on the housing.

8. The new loudspeaker structure as claimed in claim 7, wherein a substrate is connected to the housing, and the wire coil is wound on the substrate.

9. The new loudspeaker structure as claimed in claim 7 or 8, wherein the wire coil is a spiral structure.

10. The new loudspeaker structure as claimed in claim 9, wherein the coil assembly includes more than two sets of wire coils, and each set of wire coils has the connection end connected to the external power source.

11. The new loudspeaker structure as claimed in claim 7 or 8, wherein the coil assembly includes more than two sets of wire coils, each set of wire coils has the connection end connected to the external power source, and the more than two sets of wire coils are arranged in a petal-shaped structure.

12. The new loudspeaker structure as claimed in claim 1, wherein the coil assembly includes a printed coil or an etched coil disposed on the housing.

13. The new loudspeaker structure as claimed in claim 12, wherein the coil assembly further includes a substrate fixed on the housing, and the printed coil or the etched coil is disposed on the substrate.

14. The new loudspeaker structure as claimed in claim 12 or 13, wherein the printed coil or the etched coil is a spiral structure.

15. The new loudspeaker structure as claimed in claim 14, wherein the coil assembly includes more than two sets of printed coils or etched coils, each set of printed coils or etched coils has the connection end connected to the external power source, and the more than two sets of printed coils or etched coils are arranged concentrically.

16. The new loudspeaker structure as claimed in claim 12 or 13, the coil assembly includes more than two sets of printed coils or etched coils, each set of printed coils or etched coils has the connection end connected to the external power source, and the more than two sets of printed coils or etched coils are arranged in a petal-shaped structure.
